(19) United States
(12) Patent Application Publication
(10) Pub. No.: US 2007/0097976 A1
(43) Pub. Date: May 3, 2007

(54) Suspect traffic redirection

(76) Inventors: George D. Wood, Scottsdale, AZ (US); Victor Oppleman, Virginia Beach, VA (US); Brett Watson, Scottsdale, AZ (US); Rodney Joffe, Tempe, AZ (US); Zachary Kanner, Virginia Beach, VA (US); James Willett, Phoenix, AZ (US); Mark Broyles, Phoenix, AZ (US); Jesse Dunagan, Gilbert, AZ (US)

Correspondence Address: HENSLEY KIM & EDGINGTON, LLC, 1660 LINCOLN STREET, SUITE 3050, DENVER, CO, 80264, US

(21) Appl. No.: 11/437,264

(22) Filed: May 19, 2006

Related U.S. Application Data
(60) Provisional application No. 60/683,439, filed on May 20, 2005.

(51) Int. Cl. H04L 12/56

(52) U.S. Cl. 370/392; 370/401

(57) ABSTRACT

A system receives suspect traffic information pertaining to possible network threats. A router detects and redirects suspect traffic from within a subnetwork to an interrogation module. The interrogation module receives the redirected suspect traffic and identifies the source device from within the subnetwork. The interrogation module can also identify the type of suspect traffic, the original destination of the suspect traffic and the protocol type of the packet. Suspect traffic information can be updated and the router can be reconfigured to accommodate the updated information.

### CROSS-REFERENCE TO RELATED APPLICATIONS

This application claims benefit of U.S. Provisional Patent Application No. 60/683,439, entitled “Suspect Traffic Redirection” and filed on May 20, 2005, specifically incorporated herein by reference for all that it discloses and teaches.

### TECHNICAL FIELD

The invention relates generally to a computer network, and more particularly to computer network security.

### BACKGROUND

Modern computer systems are under constant threat of security breaches. Viruses, worms, data miners, key loggers, trojans, “bots”, “botnets”, spy ware, and malware are common terms used to describe types of software that can infect a computer system within a network. For example, in a common scenario, a trojan software component can be received and activated through a user's email system. A trojan is a specialized piece of software that is distributed by stealth, misdirection, or mimicry to infect other computer systems with a malicious payload. Once a trojan is received by a computer system, it can deposit the payload on the system.

Forms of malware can also be attracted by a host who is visiting a website that is infected, using an Internet connection that is compromised, or using a piece of software that has malware already resident in it. In other words, the infection can be contracted regardless of traditional security defense systems like firewalls, anti-virus software, anti-spyware software, intrusion detection systems, web proxies, and the like.

This payload often embodies autonomous software, sometimes termed a “bot”, which operates as an agent for another entity, such as a hacker, an identity thief, etc. The bot can execute within the computer system (e.g., within a company's subnetwork) and establish a connection over a network with another computer outside the company's subnetwork. In many cases, the bot is programmed to circumvent conventional security features of the computer system or the subnetwork in which it resides. For example, a bot commonly attempts to connect with the entity by probing a set of network addresses, in the hope that it will find a response. If the bot receives a response it understands from a program at one of these network addresses, the bot can maintain the connection with the remote program at that address and gather its next set of instructions from the remote program, thereby providing the remote program with access to the computer's resources from within the computer's security framework. Because the communications are initiated within the computer system and/or subnetwork rather than from another device or from the external network, traditional defense system within a company's security framework generally fail to detect the intrusions.

Existing approaches for protecting a computer against these kinds of threats include firewalls, antivirus software, spyware protection software, Intrusion Detection Systems (IDSs), Intrusion Prevention Systems (IPSs), and other types of prophylactic software and systems. However, these solutions do not adequately provide real-time detection and diagnostic information to allow a system administrator to identify an infected computer that has attracted a form of malware within the subnetwork and take corrective action.

### SUMMARY

Implementations described and claimed herein address the foregoing problems by detecting and redirecting suspect traffic from within a subnetwork and evaluating the redirected suspect traffic to identify an infected device within the subnetwork. An adaptive system receives suspect traffic information pertaining to possible network threats. A router detects and redirects suspect traffic from within a subnetwork to an interrogation module. The interrogation module receives the redirected suspect traffic and identifies the source device from within the subnetwork. The interrogation module can also identify the type of suspect traffic, the original destination of the suspect traffic and the protocol type of a packet within the suspect traffic. Suspect traffic information can be updated and the router can be reconfigured to accommodate the updated information.

In some implementations, articles of manufacture are provided as computer program products. One implementation of a computer program product provides a tangible computer program storage medium readable by a computer system and encoding a computer program. Another implementation of a computer program product may be provided in a computer data signal embodied in a carrier wave or other communication media by a computing system and encoding the computer program.

Other implementations are also described and recited herein.

### BRIEF DESCRIPTION OF THE DRAWINGS

FIG. 1 illustrates an external network and a subnetwork with an exemplary adaptive interrogation module connected within the subnetwork.

FIG. 2 illustrates an external network and a subnetwork with an exemplary adaptive interrogation module connected within the subnetwork and receiving suspect addresses.

FIG. 3 illustrates an external network and a subnetwork with an exemplary adaptive interrogation module connected within the subnetwork and configuring a router.

FIG. 4 illustrates an external network and a subnetwork with an exemplary adaptive interrogation module connected within the subnetwork, with a router redirecting suspect traffic.

FIG. 5 illustrates exemplary operations for redirecting suspect traffic.

FIG. 6 illustrates a schematic diagram of an exemplary interrogation device.

FIG. 7 illustrates an exemplary screenshot of an overview graph from an adaptive interrogation device.

FIG. 8 illustrates an exemplary screenshot of an activity graph from an adaptive interrogation device.

FIG. 9 illustrates an exemplary screenshot of a misbehaving hosts table from an adaptive interrogation device.

FIG. 10 illustrates an exemplary system useful in implementations of the described technology.

FIG. 11 illustrates another schematic diagram of an exemplary interrogation device.

### DETAILED DESCRIPTIONS

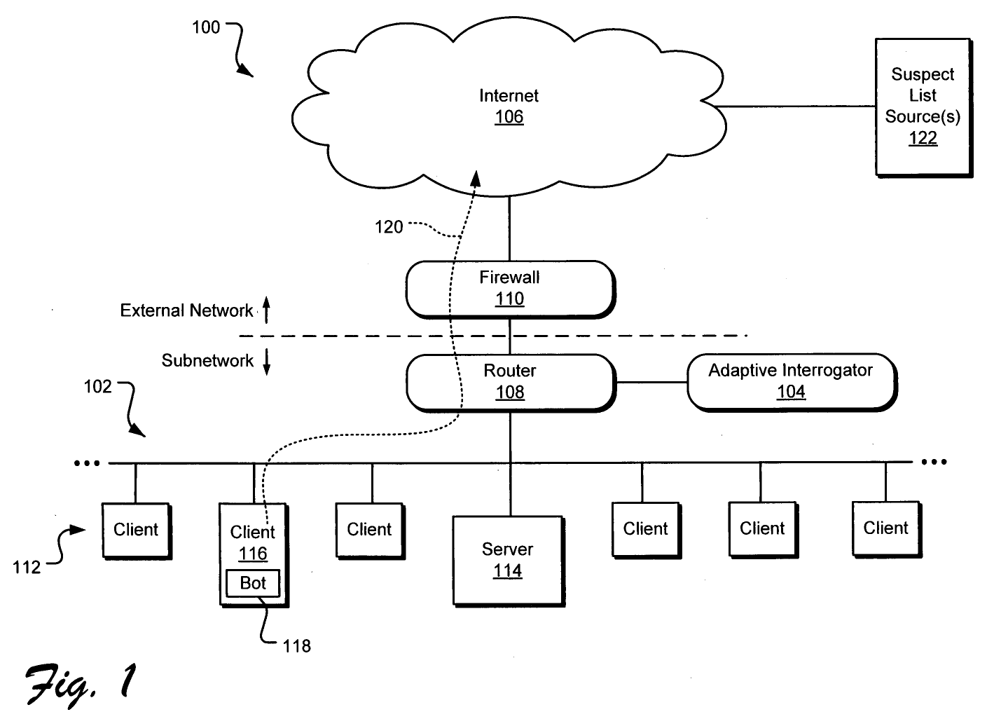

FIG. 1 illustrates an external network 100 and a subnetwork 102 with an exemplary adaptive interrogation module 104 connected within the subnetwork 102. The Internet 106 typically lies within the external network 100, although the external network 100 may not include the Internet 106 in other implementations. The subnetwork 102 is attached to the external network 100 by a router 108, a device which forwards packets between the networks. The forwarding decision is typically based on network layer information and routing tables, which are often constructed by routing protocols. A router can also be configured to handle specific network packets in a predefined way. For example, incoming packets from certain addresses can be redirected to a null address, effectively blocking the packet traffic.

In addition to the router 108, the subnetwork 102 may also be protected by a firewall 110. All messages entering or leaving the intranet pass through the firewall, which examines each message and blocks those that do not meet the specified security criteria. There are several types of firewall techniques, including without limitation:
a Packet filtering: Examining each packet entering or leaving the network and accepting or rejecting it based on user-defined rules.
Application gateway filtering: Appling security mechanisms to specific applications and services, such as FTP and Telnet servers.
Circuit-level gateway filtering: Applying security mechanisms when a TCP or UDP connection is established. Once the connection has been made, packets can flow between the hosts without further checking.
Proxy serving: Intercepting all messages entering and leaving the network. The proxy server effectively hides the true network addresses.

Various security threats exist within the external network 100 including so-called “command and control” nodes—computers executing control programs that communicate with and manipulate one or more remote malicious agents, called “bots”. Generally, bots represent noninteractive processes (i.e., not interactive with or intentionally initiated by the user) executing within a computing devices anywhere on the external network 100 and attached subnetworks. Typically, the bots are installed on these computing devices by a virus or some other malware program and are unknown to the user. For example, the virus can contain a payload containing malicious yet stealthy agent code and can be communicated by email. When the user executes the virus (e.g., by opening an infected email), the agent is installed and initiated on the user's systems. The agent can be programmed to perform a variety of operations (e.g., execute a denial-of-service attack on a given website). Alternatively, the agent can attempt to connect with a command and control node on the external network 100 and provide specific services. For example, the agent can provide sensitive information on the user's system to the command and control node. The noninteractive nature of these processes contributes to their dangerous nature because they remain unknown to the user.

In one scenario, the subnetwork 102 includes a variety of computing devices 112, including a server 114 and a client 116, which are examples of source devices that may execute noninteractive processes originating suspect traffic. The client 116 has been infected with a bot agent 118, which attempts to initiate communications 120 with an address on the external network 100 without any interaction by the user. For example, the agent 118 may scan a set of addresses on the external network 100 until it receives a response. Under typical security conditions, the router 108 and firewall 110 will not block communications from the external network 100 that are in response to a request from inside the subnetwork 102. Accordingly, by infecting the client 116 inside the subnetwork 102, a command and control node in the external network 100 may gain access to a device in the subnetwork 102.

However, a great number of the external network addresses that the agent 118 might try to contact fall into a category of suspect addresses. One category of suspect addresses may be termed “bogons”, which describes Internet Protocol (IP) blocks not allocated by the Internet Assigned Numbers Authority (IANA) and Regional Internet Registries (RIRs) to Internet Service Providers (ISPs) and other organizations. The term “bogon” can also include other IP address blocks that are reserved for private or special use by various organizations and standards. As these bogon addresses are not allocated or specially reserved, such addresses should not be routable and used on the internet. Nevertheless, some of these addresses do appear on the network, sometimes used by those individuals and organizations that are specifically trying to avoid being identified and/or involved in such activities as DoS attacks, email abuse, hacking and other security problems. Accordingly, bogons represent a type of suspect address. Other suspect address categories may also be identified. For example, IP addresses of known threats (e.g., a known hacker, a known phisher, a known pharmer, a known command and control node, etc.) can be added to the suspect address list.

Generally, the suspect addresses are available from one or more suspect address sources 122, which are shown in FIG. 1 as being exclusively external to the subnetwork 102 but which may be located external or internal to the subnetwork 102 or in some combination thereof. For example, the adaptive interrogation module 104 may receive a feed of suspect addresses from one or more sources on the external network 100 and also have access to a set of suspect addresses maintained within the subnetwork 102.

It should be understood that FIG. 1 illustrates a scenario having an adaptive interrogation module 104, but the interrogation module 104 has not effected redirection of communications from inside the subnetwork 102 to suspect addresses in the external network 100. As such, the communications 120 are passed through to the external network 100 by the router 108 and the firewall 110.

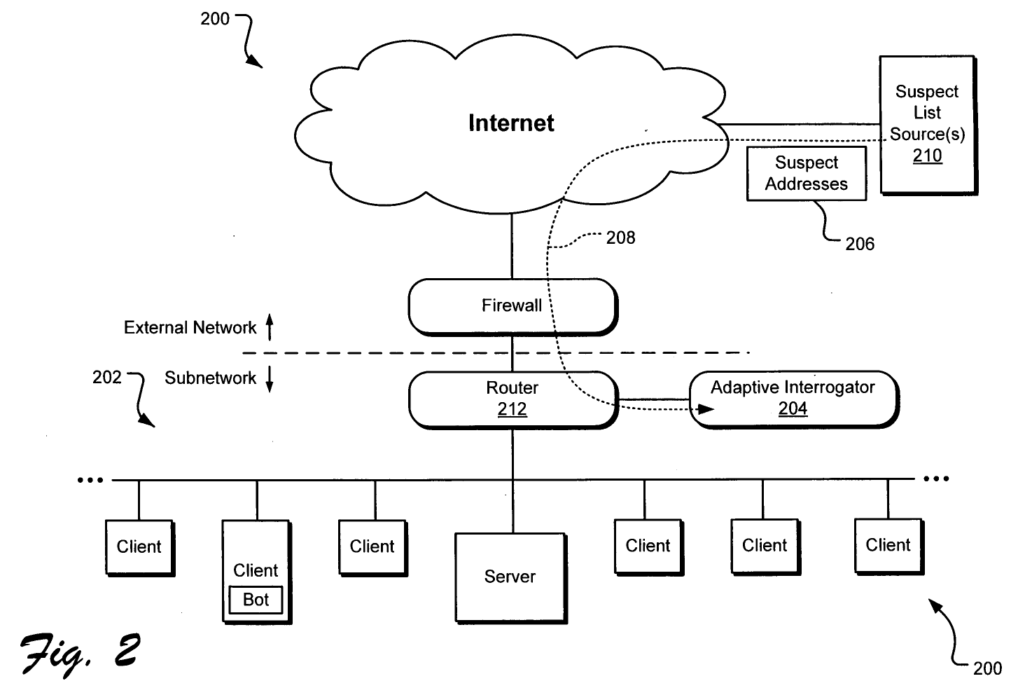

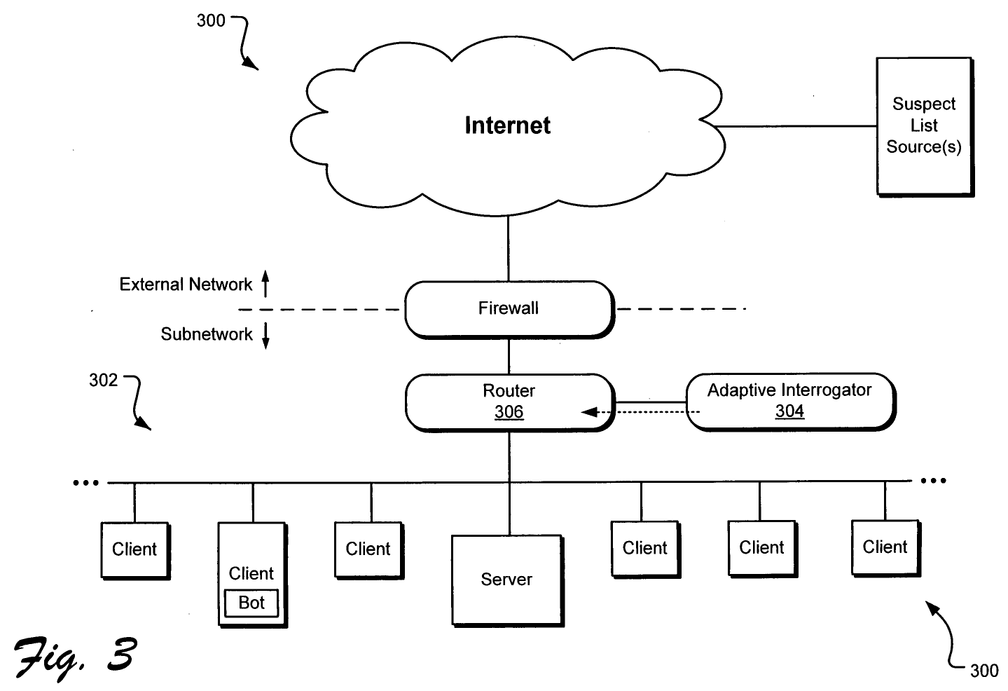

FIG. 2 illustrates an external network 200 and a subnetwork 202 with an exemplary adaptive interrogation module 204 connected within the subnetwork 202 and receiving suspect addresses 206 over communications 208. The suspect addresses 206 are received from one or more suspect address sources 210. In one implementation, the suspect addresses 206 are received by the adaptive interrogation module 204 via an administrative connection. Using the suspect addresses 206, the adaptive interrogation module 204 can configure a router 212 to redirect suspect messages to the interrogation module 204 for analysis (see, e.g., the discussion of FIG. 3).

In one implementation, one or more of the suspect address sources 210 provide the suspect addresses as a Border Gateway Protocol (BGP) announcement, although other formats may be employed, including without limitation simple lists of IP addresses in Netrange format, CIDR prefix format, CIDR bit mask format, Dotted Decimal format, and/or announcements in other routing protocols, such as OSPG and RIP. BGP is an exterior gateway routing protocol that enables groups of routers (called autonomous systems or ASs) to share routing information so that efficient, loop-free routes can be established in the Internet. BGP is commonly used within and between Internet Service Providers (ISPs). The protocol is defined in RFC 1771. The suspect addresses may also include a “type” parameter indicating the type(s) of threat each address represents (e.g., bogon, badguy, etc.). The suspect addresses may also include the type of packet (e.g., UDP, TCP, etc.), although this information may also be determined from examination of a received packet.

In one implementation, the suspect addresses 206 are updated as any one of the suspect address sources 210 receives a change to its suspect address data (e.g., a new IP address block is legitimately allocated by IANA or a new hacker site is identified). By quickly updating the suspect addresses 206, the suspect address sources 210 can provide the most up-to-date notice of possible threats. Likewise, by accepting recurrent updates, an adaptive interrogator 204 can adapt the security configuration of the subnetwork 202 to account for the changes in the suspected address 206. As updates are received by the adaptive interrogation module 204, the adaptive interrogation module 204 updates a (typically local) database of suspect addresses and reconfigures the router 212 according to the new information.

FIG. 3 illustrates an external network 300 and a subnetwork 302 with an exemplary adaptive interrogation module 304 connected within the subnetwork 302 and configuring a router 306. Generally, the suspect addresses collected by the adaptive interrogation module 304 are stored in a database and sent to the router 306 over an administration connection. The adaptive interrogation module 304 configures the router 306 to redirect messages (e.g., packets) that originate inside the subnetwork 302 and are destined for one or more suspect addresses. In one implementation, the routing table or tables in the router 306 are altered such that any packet received from the subnetwork 302 with a destination address that is a member of the suspect addresses set is forwarded to the adaptive interrogation module 304 instead of being forwarded to the external network 300 along a route to the original destination address (i.e., a suspect address). Based on this configuration, such suspect messages are redirected by the router 306 to the adaptive interrogation module 304.

With each suspect address update (or some frequency), the adaptive interrogation module 304 reconfigures the router 306 with a new set of suspect addresses, if any changes to the suspect address list have been made. In this manner, the adaptive interrogation module 304 adapts to the changes in threats from the external network 300 (e.g., as identified by suspect addresses received by the adaptive interrogation module 304).

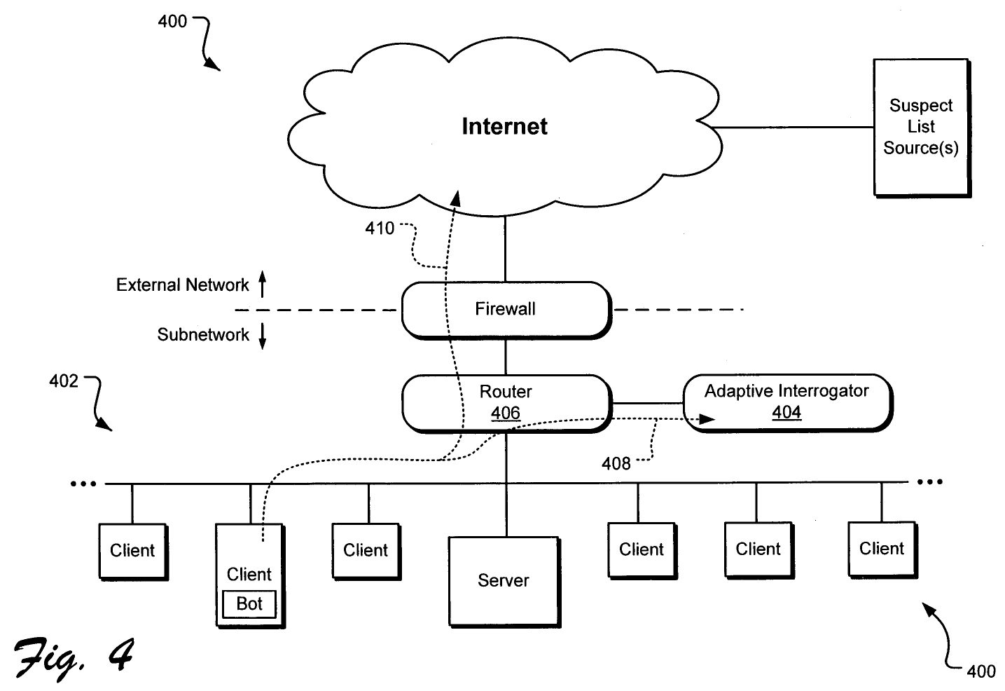

FIG. 4 illustrates an external network 400 and a subnetwork 402 with a router 406 redirecting suspect traffic to an adaptive interrogation module 404. Based on the configuration of the router 406 by the adaptive interrogation module 404, the router 406 detects any messages that originate within the subnetwork 402 and that are destined to a suspect address. In one implementation, as a router 406 typically operates at the network layer, the detection operation operates on the destination IP address of individual packets to determine whether the packets are destined for a suspect address.

It should be understood that threats could also be detected by evaluating other characteristics of a packet. For examples, another interface to the adaptive interrogation module 404 may be added to capture additional forensic/layer-4 data about a bot's behavior. Based on this behavior, an adaptive interrogation module 404 may be able to detected suspicious behavior and identify other suspect addresses not initially received from the suspect address sources.

The destination address, or some part thereof, of an outgoing packet is evaluated against addresses or address ranges in the routing table of the router 406. In one implementation, the routing table includes entries for the suspect addresses (as configured by the adaptive interrogation module 404). Such entries include an address for the adaptive interrogation module 404 as a forwarding address. In this manner, when the router 406 routes packets received from within the subnetwork 402, suspect packets are redirected to the adaptive interrogation module 404 (see communications path 408) while non-suspect packets are forwarded to an address in the appropriate routing sequence (see communications path 410).

Although FIGS. 1-4 suggest an adaptive interrogator module physically located “within” a subnetwork, it should be understood that suspects packets may be redirected from within the subnetwork to an adaptive interrogator module that is remotely connected, such as via a VPN, a dedicated communication line, a secure tunnel, etc. As such, a remote adaptive interrogator module may be employed to interrogate outgoing subnetwork traffic for one or more subnetworks.

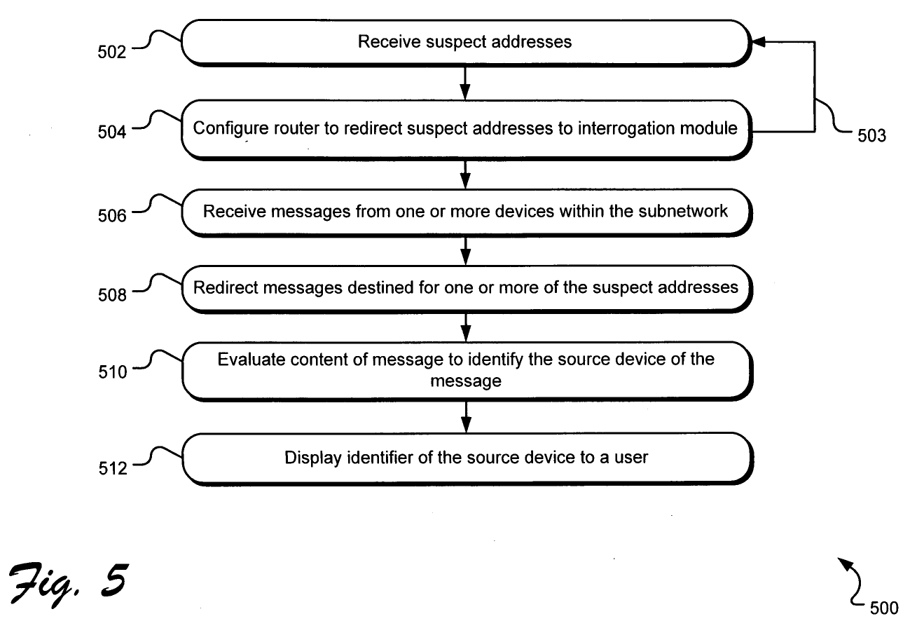

FIG. 5 illustrates exemplary operations 500 for redirecting suspect traffic. A receiving operation 502 receives suspect addresses from a suspect address source. In one implementation, the suspected addresses are received in a BGP format, although other formats are also contemplated. Based on the received suspect addresses, a configuration operation 504 configures a router to redirect packets received by the router from within the subnetwork and destined for a suspect address in the external network. The destination of the redirection is an adaptive interrogation module, which can be integral to the router or separate from the router. As represented by the arrow 503, the receiving operation 502 and the configuration operation 504 can cycle continually as the set of suspect addresses is updated.

Another receiving operation 506 receives messages from within the subnetwork. If a received message is destined for a suspect address in the external network, the message (e.g., one or more IP packets) is redirected to the adaptive interrogation module in a redirection operation 508. An evaluation operation 5 1 0 examines the redirected packet to identify the source device that attempted to send the message out of the subnetwork. Such examination may be accomplished by examining message header data, payload data, or metadata to determine the source address or other source identifier. A display operation 512 displays the source address, the message type, the suspect address type, or other message-related information.

Identification of the source device may be accomplished in various circumstances. In one example, the source device uses an external IP address instead of a Network Address Translation (NAT) address. In this circumstance, the source address of the redirected packet may identify the source device that originated the suspect packet. Alternatively, if the subnetwork is using NAT, the adaptive interrogation module may be farther “inside” the subnetwork than the device providing the translation. Therefore, the IP address of the redirect packet may still identify the source device that originated the suspect packet. In yet another configuration, the NAT device may maintain static 1-to-1 NAT-to-public address mappings, where public addresses can be directly translated to the NAT addresses.

Other methods for identifying the source device of a suspect packet may be employed, including a brute force isolation of devices and branches within the subnetwork until the source device can be identified by changes in the redirected traffic. Alternatively, an additional port may be used to monitor traffic arrive at the NAT device from the local devices within the subnetwork, matching that traffic to corresponding external traffic, and building a table of connections for external mapping. In yet another configuration, if the subnetwork employs 1:1 NAT, but the internal addresses are assigned by the Dynamic Host Configuration Protocol (DHCP) (e.g., the mappings are not static), then the adaptive packet interrogation module may access the DHCP logs or a database of DHCP assignments. In subnetworks employing a NAT device, the NAT device itself may be queried to provide the IP or MAC address of the source device (e.g., using address, port, and timestamp logs).

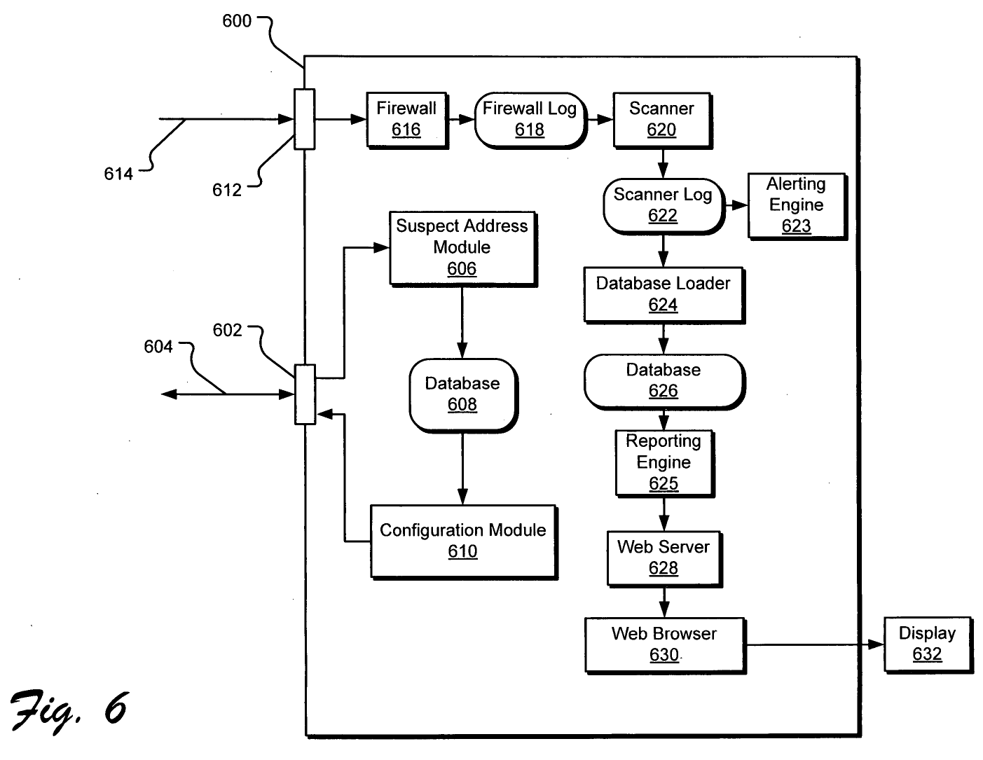

FIG. 6 illustrates a schematic diagram of an exemplary interrogation device 600. An administration interface 602 is coupled to a communications link 604. In some implementations, this link 604 is a wired connection, although wireless connections are also contemplated. One or more feeds of suspect address information are received via the administration interface 602 and passed to a suspect address module 606, which extracts the suspect addresses from the suspect address information and loads them into a database 608. A configuration module 610 extracts the suspect address from the database 608 and causes suspect traffic to be redirected to a port 612 in the adaptive interrogation module 600. In one implementation, for example, the configuration module 610 reconfigures a router to redirect such traffic (e.g., by causing one or more router tables to be altered) via a link 614. The link 614, which is coupled to the traffic interface 612 by a wired or wireless connection, may couple the adaptive interrogation module 600 to a router or some other device or module capable of detecting suspect traffic and forwarding the suspect traffic to the adaptive interrogation module 600.

As mentioned, suspect traffic is redirected via the link 614 to the traffic interface 612. The suspect traffic passes through a firewall module 616, which logs the traffic, including source and destination addresses and hostnames of individual packets, if appropriate, into a firewall log 618. A scanner module 620 reads the firewall log 618 and loads the read data into a scanner log 622, which also includes the source and destination addresses of individual packets. In one implementation, the scanner module 620 can determine whether packets have suspicious addresses (e.g., based on the addresses in the database 608), and if so, why they are considered suspicious (e.g., if they are addressed to unassigned address space, they are deemed “bogons”, and if they are addressed to known command and control sites, they are deemed “bad guys”). For example, the address may be associated within the database 608 with a specific suspicious packet type. The scanner log 622 has a format understood by an alerting module 623, which allows syslog, email, and text message alerting of events, as well as a database loader 624, which loads the scanner log data into a database 626. A reporting engine 625 reads data from the database 626 and formats reports for the web server 628 as well as allowing for additional future reporting export functionality. A web server module 628 is capable of accessing the reporting engine 625 and constructing web pages containing the reporting data. A browser module 630 receives the reporting data from the web server module 628 and displays the reporting data on a display 632.

As discussed, the scanner module 620 can determine the suspect traffic type of a packet. In one implementation, a brute force loop comparing packet addresses to addresses in the database 608 is used to determine the suspect traffic type of each packet. Alternative methods may be employed, including without limitation hash table lookups, sparse arrays, lookups based on binary trees, etc. In another implementation, the PATRICIA (Practical Algorithm to Retrieve Information Coded in Alphanumeric) Trie algorithm is used.

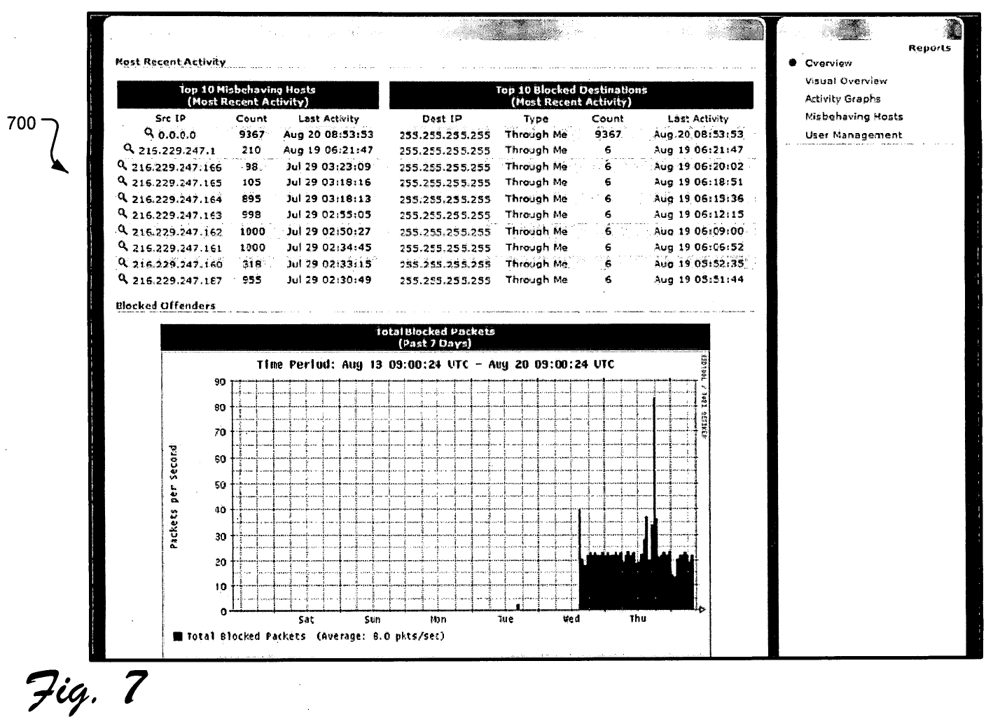

FIG. 7 illustrates an exemplary screenshot 700 of an overview display from an adaptive interrogation device in an active (blocking) mode. The top left table shows the top ten source devices in the subnetwork that have attempted to send messages (e.g., IP packets) to suspect addresses. The top right table shows the top ten suspect address to which devices within the subnetwork have attempted to send messages, where “blocked” in the figure implies “redirected to the adaptive interrogation module instead of the suspect address”. The bottom table shows a graphical representation of the times when source devices within the subnetwork attempted to send suspect traffic into the external network.

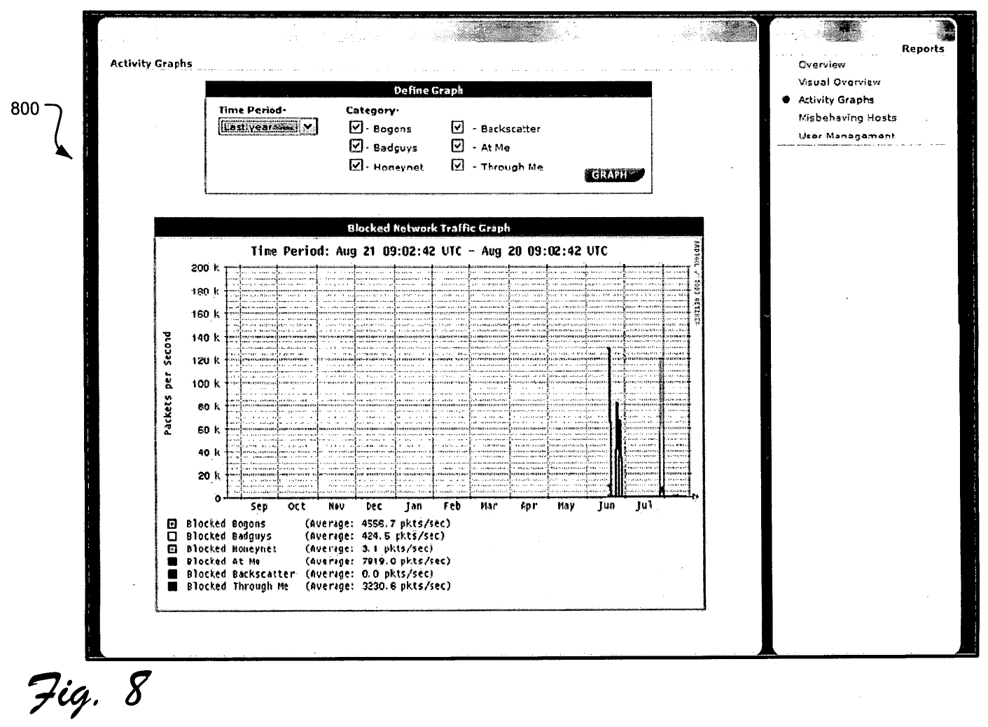

FIG. 8 illustrates an exemplary screenshot 800 of an activity graph from an adaptive interrogation device. The graph illustrates times when suspect traffic was received by the adaptive interrogation module and what type of suspect traffic it was. Exemplary suspect traffic types are identified below:

TABLE 1
Suspect Traffic Types

| Type of | |
|---|---|
| Suspect | |
| Traffic | Description |
| Bogons | Unallocated or reserved IP addresses |
| Badguys | Identified command and control node addresses or other |
| | identified threat addresses |
| Honeynet | Address space within a subnetwork that is not allocated |
| | to legitimate devices within the subnetwork but is |
| | allocated to detect “bots” scanning from within |
| | the subnetwork. For example, if 10.8.0.0 is not |
| | allocated to a legitimate device, then any device |
| | attempting to send a packet to that address may be a |
| | “bot”. |
| At Me | The destination IP address is set to the address of the |
| | adaptive interrogation module. This event signifies an |
| | attack on the security framework and specifically the |
| | adaptive interrogation module. |
| Backscatter | A malicious device in the external network can spoof |
| | legitimate source addresses within the subnetwork |
| | during a denial-of-service (DoS) or ping attack on |
| | another device. The attacked node bounces the attacks |
| | back to the spoofed source address (in the subnetwork), |
| | providing the adaptive interrogation module with the |
| | source address of the attacked node. |
| Through Me | An attempt has been made to route a suspect packet |
| | through the adaptive interrogation device to some other |
| | destination address, absent determination of some other |
| | suspect traffic type. |

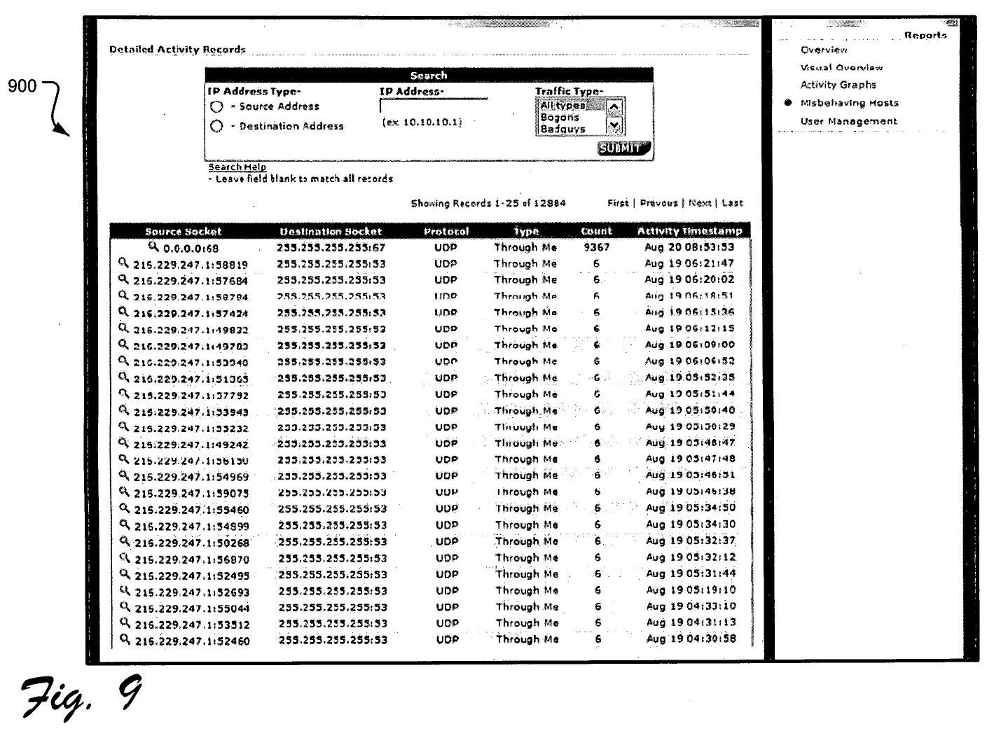

FIG. 9 illustrates an exemplary screenshot 900 of a misbehaving hosts table from an adaptive interrogation device. The table lists: the source address, hostname, the destination address, the type of packet (e.g., protocol), the type of suspect address, a count of the number of received packets of that identified characteristic, and a timestamp for the packets receipt by the adaptive interrogation module.

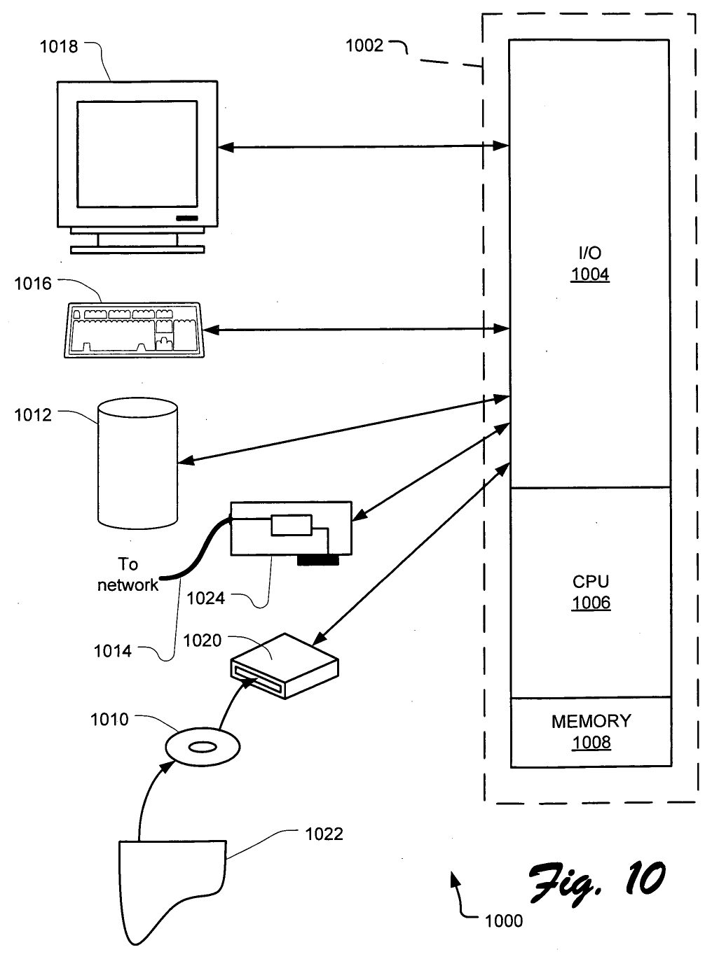

FIG. 10 illustrates an exemplary system useful in implementations of the described technology. A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 10 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer. The described technology is optionally implemented in software devices loaded in memory 1008, stored on a configured DVD/CD-ROM 1010 or storage unit 1012, and/or communicated via a wired or wireless network link 1014 on a carrier signal, thereby transforming the computer system 1000 in FIG. 10 to a special purpose machine for implementing the described operations.

The I/O section 1004 is connected to one or more user-interface devices (e.g., a keyboard 1016 and a display unit 1018), a disk storage unit 1012, and a disk drive unit 1020. Generally, in contemporary systems, the disk drive unit 1020 is a DVD/CD-ROM drive unit capable of reading the DVD/CD-ROM medium 1010, which typically contains programs and data 1022. Computer program products containing mechanisms to effectuate the systems and methods in accordance with the described technology may reside in the memory section 1004, on a disk storage unit 1012, or on the DVD/CD-ROM medium 1010 of such a system 1000. Alternatively, a disk drive unit 1020 may be replaced or supplemented by a floppy drive unit, a tape drive unit, or other storage medium drive unit. The network adapter 1024 is capable of connecting the computer system to a network via the network link 1014, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 1000 is connected (by wired connection or wirelessly) to a local network through one or more network interfaces or adapters 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are exemplary and other means of and communications devices for establishing a communications link between the computers may be used.

In accordance with an implementation, software instructions and data directed toward receiving suspect addresses, causing redirection of suspect traffic, identifying a source device sending a suspect message, and other operations may reside on disk storage unit 1009, disk drive unit 1007 or other storage medium units coupled to the system. Said software instructions may also be executed by CPU 1006.

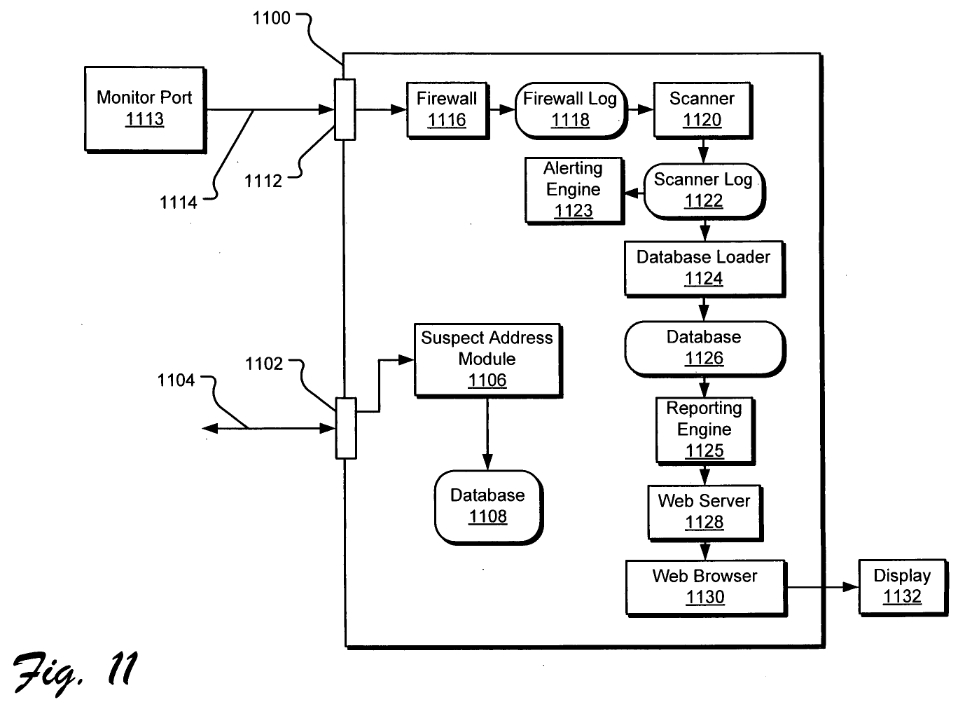

FIG. 11 illustrates a schematic diagram of an exemplary adaptive system with interrogation module 1100 in a passive (listening) mode. An administration interface 1102 is coupled to a communications link 1104. In some implementations, this link 1104 is a wired connection, although wireless connections are also contemplated. One or more feeds of suspect address information are received via the administration interface 1102 and passed to a suspect address module 1106, which extracts the suspect addresses from the suspect address information and loads them into a database 1108. The port 1112 is attached to a monitored or tapped connection 1113 between the core switch and the router, or some other network segment where a passive (listening) mode device is desired.

Here, suspect traffic is monitored via the link 1114 to the traffic interface 1112. The suspect traffic passes through a firewall module 1116, which logs the traffic, including source and destination addresses of individual packets, if appropriate, into a firewall log 1118. A scanner module 1120 reads the firewall log 1118 and loads the addresses that are determined to be suspicious (based on the suspect address information) into a scanner log 1122, which also includes the source and destination addresses and hostnames of individual packets. In one implementation, the scanner module 1120 can determine whether packets have suspicious addresses (e.g., based on the addresses in the database 1108), and if so, why they are considered suspicious (e.g., if they are addressed to unassigned address space, they are deemed “bogons”, and if they are addressed to known command and control sites, they are deemed “bad guys”). For example, the address may be associated within the database 1108 with a specific suspicious packet type. The scanner log 1122 has a format understood by an alerting engine 1123 which allows syslog, email and text message alerting of events, as well as a database loader 1124, which loads the scanner log data into a database 1126. A reporting engine 1125 reads data from the database 1126 and formats reports for the web server 1128 as well as allowing for addition future reporting export functionality. A web server module 1128 is capable of accessing the reporting engine 1125 and constructing web pages containing the reporting data. A browser module 1130 receives the reporting data from the web server module 1128 and displays the reporting data on a display 1132.

The scanner module 1120 can use a variety of mechanisms for passing data to the alerting engine 1123 and the suspicious activity databases. In one implementation, the scanner module 1120 can write directly to a log file, which is then read independently by the alerting engine 1123 or other modules. In an alternative implementation, the scanner module 1120 can use a syslog facility (e.g., a standard syslog facility or syslog-ng) to write to a log file and to directly trigger other alerting and/or logging action. In yet another implementation, the scanner module 1120 can send messages to the alerting engine 1123 using standard or proprietary interprocess communications (IPC) channels, either locally or across a communications network. Such IPC mechanisms may include UNIX or Internet Domain sockets, named pipes, and other system-based or proprietary mechanisms. Likewise, the firewall module 1116 may use similar methods to pass data to the scanning module 1120. Other communications methods are also contemplated.

As discussed, the scanner module 1120 can determine the suspect traffic type of a packet. In one implementation, a brute force loop comparing packet addresses to addresses in the database 1108 is used to determine the suspect traffic type of each packet. Alternative methods may be employed, including without limitation hash table lookups, sparse arrays, lookups based on binary trees, etc. In another implementation, the PATRICIA (Practical Algorithm to Retrieve Information Coded in Alphanumeric) Trie algorithm is used.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

It should be understood that logical operations described and claimed herein may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A method comprising:
receiving within a subnetwork a set of suspect addresses, wherein the subnetwork is coupled to an external network and the suspect addresses represent device addresses in the external network;
detecting a message that originates from a noninteractive process of a source device within the subnetwork and is destined to at least one of the suspect addresses in the external network;
redirecting the message to an interrogation module; and
identifying the source device within the subnetwork based on the message.

2. The method of claim 1 further comprising:
configuring a router in the subnetwork to redirect messages that originate from a source device within the subnetwork and are destined to at least one of the suspect addresses in the external network.

3. The method of claim 2 further comprising:
receiving within the subnetwork an updated set of suspect addresses in the external network; and
configuring a router in the subnetwork to redirect messages that are destined to at least one of the suspect addresses in the updated set of suspect addresses in the external network.

4. The method of claim 1 further comprising:
altering a routing table of a router in the subnetwork to redirect messages that originate from a source device within the subnetwork and are destined to at least one of the suspect addresses in the external network.

5. The method of claim 4 further comprising:
receiving within the subnetwork an updated set of suspect addresses in the external network; and
altering a routing table of a router in the subnetwork to redirect messages that are destined to at least one of the suspect addresses in the updated set of suspect addresses in the external network.

6. The method of claim 1 wherein the set of suspect addresses in the external network is received in Border Gateway Protocol format.

7. The method of claim 1 wherein the detecting operation comprises:
determining that the message includes a destination address that is a member of the set of suspect addresses.

8. The method of claim 1 wherein the detecting operation comprises:
determining that the message includes a source address that within the subnetwork.

9. The method of claim 1 wherein the redirecting operation comprises:
forwarding the message to a forwarding address in a routing table, wherein the forwarding address is associated with a suspect address in the routing table.

10. The method of claim 1 wherein a router receives the message and the redirecting operation comprises:
forwarding the message to the interrogation module within the router.

11. The method of claim 1 wherein a router receives the message and the redirecting operation comprises:
forwarding the message to an interrogation module at another address within the subnetwork.

12. The method of claim 1 wherein the identifying operation comprises:
examining the message to determine the source device address within the subnetwork.

13. The method of claim 1 wherein the identifying operation comprises:
examining the message to determine the destination address within the external network.

14. The method of claim 1 further comprising:
determining a type of suspect address to which the message was destined.

15. The method of claim 14 wherein the determining operation employs an implementation of the Practical Algorithm to Retrieve Information Coded in Alphanumeric to determine the type of suspect address to which the messages was destined.

16. The method of claim 1 further comprising:
determining the protocol type of the message.

17. A computer program product encoding a computer program for a computer process that executes on a computer system, the computer process comprising:
receiving within a subnetwork a set of suspect addresses, wherein the subnetwork is coupled to an external network and the suspect addresses represent device addresses in the external network;
detecting a message that originates from a process of a source device within the subnetwork and is destined to at least one of the suspect addresses in the external network, wherein the process has not been intentionally initiated by an authorized user of the client device;
redirecting the message to an interrogation module; and
identifying the source device within the subnetwork based on the message.

18. The computer program product of claim 17 wherein the computer process further comprises:
configuring a router in the subnetwork to redirect messages that originate from a source device within the subnetwork and are destined to at least one of the suspect addresses in the external network.

19. The computer program product of claim 18 wherein the computer process further comprises:
receiving within the subnetwork an updated set of suspect addresses in the external network; and
configuring a router in the subnetwork to redirect messages that are destined to at least one of the suspect addresses in the updated set of suspect addresses in the external network.

20. The computer program product of claim 17 wherein the computer process further comprises:
altering a routing table of a router in the subnetwork to redirect messages that originate from a source device within the subnetwork and are destined to at least one of the suspect addresses in the external network.

21. The computer program product of claim 20 wherein the computer process further comprises:
receiving within the subnetwork an updated set of suspect addresses in the external network; and
altering a routing table of a router in the subnetwork to redirect messages that are destined to at least one of the suspect addresses in the updated set of suspect addresses in the external network.

22. The computer program product of claim 17 wherein the set of suspect addresses in the external network is received in Border Gateway Protocol format.

23. The computer program product of claim 17 wherein the detecting operation comprises:
determining that the message includes a destination address that is a member of the set of suspect addresses.

24. The computer program product of claim 17 wherein the detecting operation comprises:
determining that the message includes a source address that within the subnetwork.

25. The computer program product of claim 17 wherein the redirecting operation comprises:
forwarding the message to a forwarding address in a routing table, wherein the forwarding address is associated with a suspect address in the routing table.

26. The computer program product of claim 17 wherein a router receives the message and the redirecting operation comprises:
forwarding the message to the interrogation module within the router.

27. The computer program product of claim 17 wherein a router receives the message and the redirecting operation comprises:
forwarding the message to an interrogation module at another address within the subnetwork.

28. The computer program product of claimed 17 wherein the identifying operation comprises:
examining the message to determine the source device address within the subnetwork.

29. The computer program of claim 17 wherein the identifying operation comprises:
examining the message to determine the destination address within the external network.

30. The computer program product of claim 17 further comprising:
determining a type of suspect address to which the message was destined.

31. The computer program product of claim 30 wherein the determining operation employs an implementation of the Practical Algorithm to Retrieve Information Coded in Alphanumeric to determine the type of suspect address to which the messages was destined.

32. The computer program products of claim 17 further comprising:
determining the protocol type of the message.

33. A system comprising:
an interface within a subnetwork a set of suspect addresses, wherein the subnetwork is coupled to an external network and the suspect addresses represent device addresses in the external network;
a router detecting a message that originates from a noninteractive process of a source device within the subnetwork and is destined to at least one of the suspect addresses in the external network and redirecting the message; and
an interrogation module receiving the redirected message and identifying the source device within the subnetwork based on the message.

34. A method comprising:
receiving within a subnetwork a set of suspect addresses, wherein the subnetwork is coupled to an external network and the suspect addresses represent device addresses in the external network;
receiving a redirected message, the redirected message originating from a noninteractive process of a source device within the subnetwork and being previously destined to at least one of the suspect addresses in the external network; and
identifying the source device within the subnetwork based on the message.

35. A computer-readable medium having computer-executable instructions for performing a computer process that implements the operations recited in claim 34.

36. A system comprising:
an interface receiving within a subnetwork a set of suspect addresses, wherein the subnetwork is coupled to an external network and the suspect addresses represent device addresses in the external network; and
an adaptive interrogation module receiving a redirected message, the redirected message originating from a source device within the subnetwork and being previously destined to at least one of the suspect addresses in the external network and identifying the source device within the subnetwork based in the message.
